(19) United States
(12) Patent Application Publication
(10) Pub. No.: US 2006/0246247 A1
(43) Pub. Date: Nov. 2, 2006

(54) LABEL SUPPLY AND RELATED METHOD OF MANUFACTURE

(75) Inventor: Guy S. Kiraly, Germantown, TN (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CCL LABEL, INC., Memphis, TN (US)

(21) Appl. No.: 11/278,490

(22) Filed: Apr. 3, 2006

Related U.S. Application Data
(60) Provisional application No. 60/675,636, filed on Apr. 28, 2005.

(51) Int. Cl. B29C 53/78; B31C 1/00; B32B 33/00

(52) U.S. Cl. 428/41.8; 156/195; 156/184

(57) ABSTRACT

A label construction, which includes a web having labels, transverse wound on a spool. The web can include adjacent labels having an optional void between those labels. Labels of overlying layers of the label web can optionally nest within the void of an underlying label web layer. The label web can be constructed such that the length of any label on the web is less than the circumference of a spool on which the web is wound. Further optionally, the label web can include a plastic liner that is resistant to tearing when the web is transverse wound on a spool. A method of making the label construction is also provided in which the label construction is wound on a spool so that overlying web layers are transverse to underlying web layers.

This application claims benefit to U.S. Provisional Patent Application No. 60/675,636, filed Apr. 28, 2005, which is hereby incorporated by reference.

### BACKGROUND OF THE INVENTION

The present invention relates to labels, and more particularly to labels mounted on spools for rapid, mechanized application to products.

Many labels are manufactured in web form to facilitate rapid transfer of those labels to a product with a labeling machine. The labels include label stock having images or text printed on a first side, and a pressure sensitive adhesive on the opposite second side. A packet, compartment or blister containing a sample, an accessory or prize can be secured to the first side as desired. Multiple, individual labels can be adhered with the pressure sensitive adhesive to a long, continuous web of paper release liner to form a label web.

To configure the label web into a form that is more manageable and easy to dispense individual labels from, the label web is wound onto a spool. Specifically, one end of the spool is secured to the core of the spool, and the spool is rotated. The rotation causes the web to wind over itself repeatedly so that the individual labels are stacked directly over one another, with the edges of the labels from one layer of the web to the next generally vertically aligned with one another. A spool manufactured in such a manner is typically referred to as a pancake wound label spool.

Although such a spool wound label web provides a web to package a large number of labels, it suffers several shortcomings. First, if the labels are thick, the web piles up on itself quickly on the spool. Accordingly, a limited number of labels can be wound on a spool. Second, this rapid pile-up problem is compounded if the label includes an additional packet, compartment or blister.

### SUMMARY OF THE INVENTION

The aforementioned problems are overcome by a construction including a web of labels transverse wound on a spool.

In one embodiment, the web includes multiple labels, each joined with a plastic release liner via a pressure sensitive adhesive. The labels can be arranged serially along the plastic release liner. The label web can be wound so that it repeatedly spirals from a first end of the spool to a second end of the spool, and then back to the first end. Accordingly, each overlying layer of web—that is, a length of the web that is wound over another portion of the web on the spool—is transverse to at least a portion of an underlying layer of the web.

In another embodiment, adjacent labels are spaced from one another a distance on the release liner, thereby forming a void or recess between each adjacent label. The web can be wound so that the labels of an overlying web layer lie at least partially in or adjacent the voids between adjacent labels of an underlying web layer. Accordingly, the labels of the web in overlying layers neatly pack or nest in underlying label web layer.

In yet another embodiment, each label on the web can include a booklet, a compartment and/or a blister, with each booklet spaced a distance from a booklet of an adjacent label to form a void or recess between each booklet. The label web can be transverse wound so that the booklets of an overlying layer at least partially fit in the void between adjacent booklets in an underlying layer.

In a further embodiment, the spool can include a defined core (that is, a physical core, other than the innermost layers of the label web wound to form a cylinder) on which the label is wound. The core can include a circumference that is at least as great as the length of any individual label included on the label web.

The construction including a label web transverse wound on a spool provides an efficient way to increase the number of labels that can be wound on a spool. With multiple overlying web layers transversely wound over underlying web layers, the volume of labels on a spool can be increased. Where the labels of an overlying web layer at least partially nest between adjacent labels of an underlying web layer, the web can be tightly wound without damaging the labels and any booklets, compartments or blisters associated with the labels. Accordingly, the total volume of labels on a web included on a single spool can be significantly increased, and in some cases, such spools can store about 50% to about 150% more labels in web form when compared to conventional pancake wound spools.

These and other objects, advantages and features of the invention will be more readily understood and appreciated by reference to the detailed description of the invention and the drawings.

### BRIEF DESCRIPTION OF THE DRAWINGS

FIG. 1 is a perspective view of a portion of a label web including several exemplary labels according to a first embodiment;

FIG. 2 is a perspective view of a portion of a label web including several alternative exemplary labels according to a second embodiment;

FIG. 3 is a side view of a spool including the label web wound on a spool of a first embodiment;

FIG. 4 is a side view of a spool including a label web on a spool of a second embodiment; and

FIG. 5 is a section view of the spool including a label web of the second embodiment taken along line 5-5 of FIG. 5.

### DETAILED DESCRIPTION OF THE PREFERRED EMBODIMENT

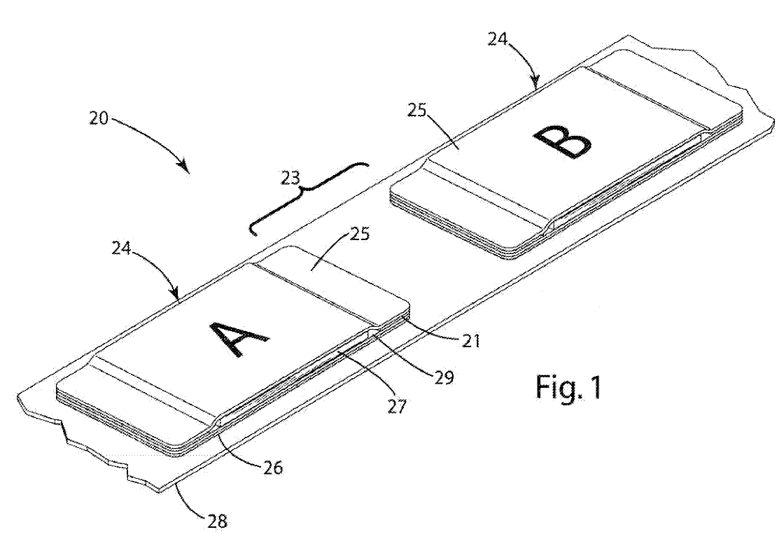

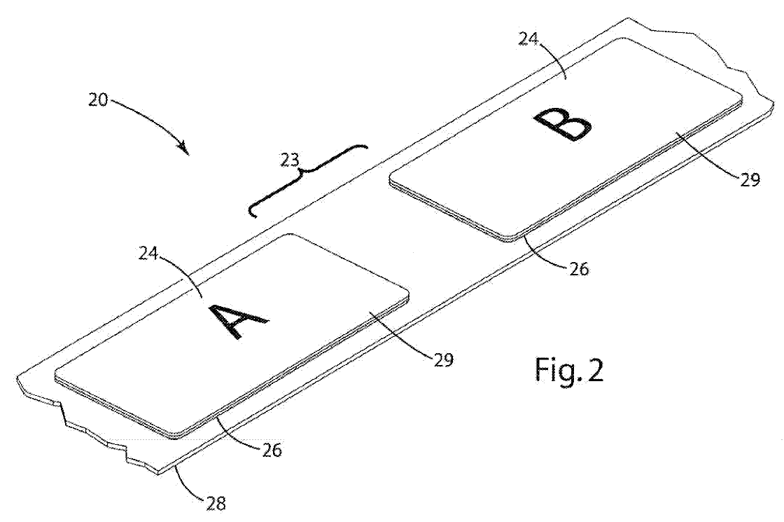

A label web suitable for use in the present invention including multiple labels is shown in FIG. 1, and generally designated 20. The label web 20 can include a variety of different labels 24, including flat pressure sensitive labels, labels including booklets, expanded content labels, labels including blisters and packets that contain items, and the like. The label can be an expanded content label including an overlaminate 24 which is secured over a booklet 27 and to a base 29 with an overlaminate adhesive 21. The booklet can be any type of booklet, for example a fan fold type booklet, an edge bound booklet, or a map type booklet. The base 29 can be joined with a continuous release liner 28 by way of a pressure sensitive adhesive 26. Individual labels on the web can be spaced from one another to form a recess or void 23 therebetween. This void can be of a pre-selected length corresponding to a portion of the length of each individual label, for example, about 25%, about 50%, about 75% and greater than about 100% the length of an individual label. Alternatively, as shown in FIG. 2, an alternative label web 20 can include a series of flat pressure sensitive labels 24, secured to a continuous release liner 28 with adhesive 26. Voids 23 can be between adjacent labels 24 as well.

The labels and release liner of any of the above label webs, and any other components of the webs, can be constructed from a variety of materials, including paper, plastic, foil, metals, and the like. It has been discovered, however, that when the liner is constructed from plastic, for example, polyethylene terephthalate (PET) or other comparable plastic materials, surprising results are observed. Specifically, the label web 28 is resistant to significant tearing, crimping, wrinkling, fracturing or damage due to the forces exerted on the web when wound on the spool. Further, the label web can be of any width desired, for example, about 1 inch, 2 inches, 3 inches or 4 inches. Likewise, individual labels can be of any length desired, for example, about 4 inches, 5 inches, 6 inches, 10 inches, 15 inches or 20 inches.

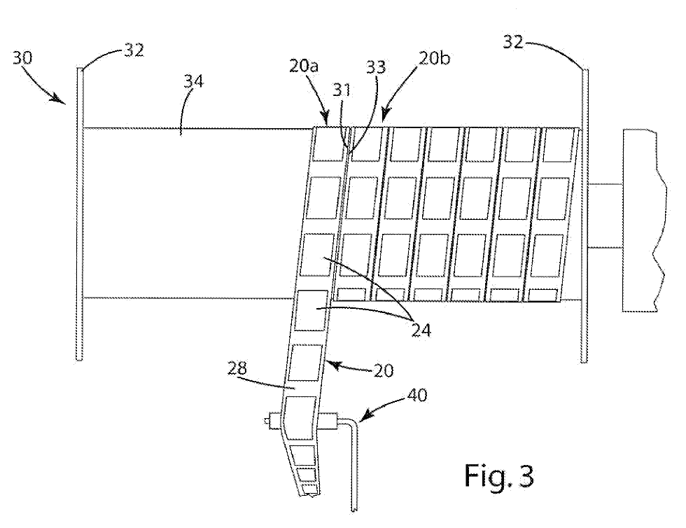

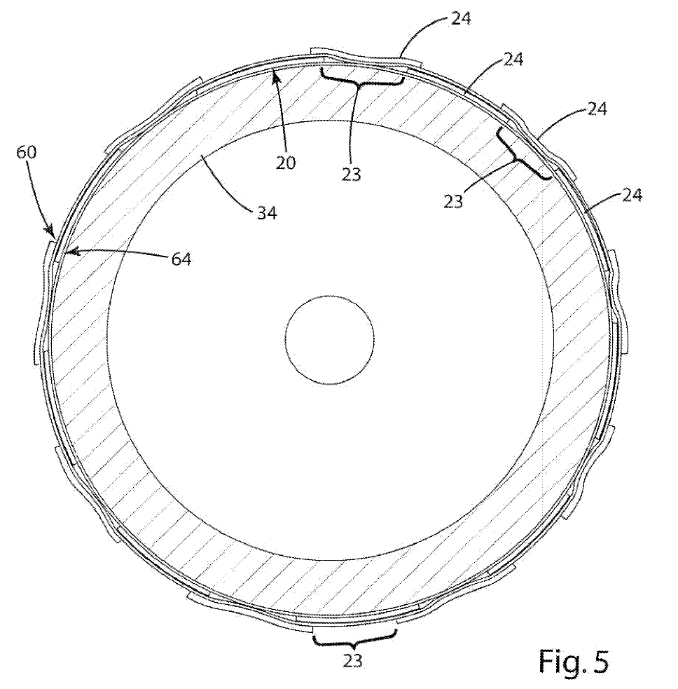

As shown in FIG. 3, the construction 10 of the present invention is constructed with a label web 20, for example, either of the webs described above, being wound on a spool 30. The spool 30 can include end flanges 32 which can define the outer extent to which the label web 20 is wrapped around the core 34. The spool and its components can be constructed from paperboard, plastic, metal, or any other desirable material. The core 34 can be of any size or shape, for example circular, elliptical, square, and/or triangular. In the embodiment shown, the core is of a circular cross section, and includes a circumference, which can be pre-selected based on the length of each individual label. For example, the core circumference can exceed the length of an individual label 24 on the label web (FIG. 5). When the construction 10 includes this optional core 34 dimension, it has been discovered that the web 20 wraps easily around the core without tearing or damaging the web or individual labels or the release liner 28.

Referring to FIG. 3, the first layer of a label web 20 can be initially wound on the spool, with the label web 20 optionally beginning at one of the end flanges 32. The web can be wound around the core in a spiral manner, such that within a single layer of the web, the edge 31 of each new portion of the label web 20a wound on the spool abuts or is adjacent the edge 33 of a previously wound portion of the label web 20b. In some applications, the edges of a single layer may overlap as desired, for example, edge 31 may overlap edge 33. Generally, the label web is rolled over and over upon itself to form a cylindrical (or other shaped) roll on the spool. In some applications, where the liner material is rigid enough, the core and spool components can be wholly or partially eliminated from the construction so that the label web is simply wound on its inner layers to form a roll. Also illustrated in FIG. 3 is a label web winder 40 which can be guided back and forth along an axis parallel to the axis of the spool as the spool rotates to apply the web to the spool in the desired manner.

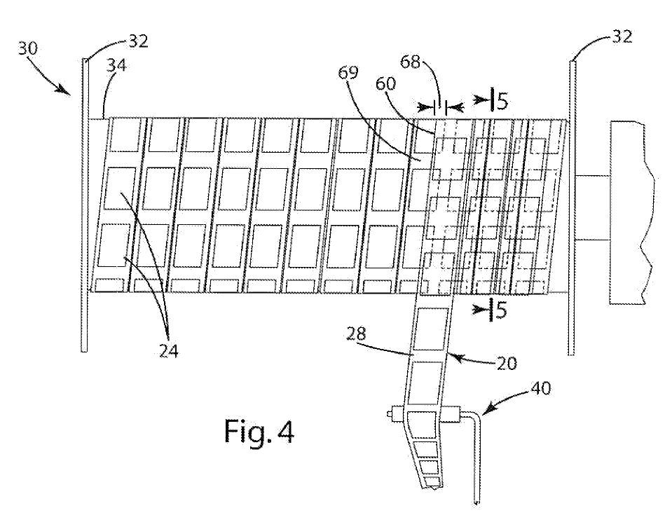

With reference to FIG. 4, a subsequent layer, that is, an overlying web layer 60, is shown being transversely wound over a previous layer, that is, an underlying web layer 64. As shown, the overlying web layer is wrapped transversely on the core 34 so that each overlying layer 60 overlaps across a portion 68 of a previous layer 64 a pre-selected distance, for example at least about 0.25 inch, 0.5 inch, 0.75 inch, 1 inch, 1.25 inches, 1.5 inches, 1.75 inches, 2 inches, or any other distance depending on the label and/or web size. With this transverse wound configuration, it has been discovered that the number of labels wound on a spool can be about 50% to about 150% greater than that provided by a label web wound in a conventional pancake manner on a spool. Thus, with transverse label winding, the density of labels wound on a label supply can be increased.

A further example of density improvement can be shown in FIG. 5. There, the label web 20 is transversely wound on the spool 34. The overlying layer 60 is wound over the underlying layer 64 in transverse manner with the overlying layer 60 overlying at least a portion of the underlying layer 64. As shown, a portion of the labels 24 in an overlying layer 60 can nest at least partially in a void 23 between adjacent labels in an underlying layer. Optionally, the label length, and the void 23 between adjacent labels, as well as degree of overlap can be selected so that the labels of an overlying layer are positioned generally over the void, and at least partially fit within the void to further reduce the amount of space required for the label web on the spool. In turn, either or both of the transverse winding and the void-label nesting can increase the density of labels wound on a spool over other label storage techniques, for example, pancake wound techniques.

To manufacture the label construction or supply 10 of the present invention, the label web shown in FIGS. 1, 2 or any other label web construction are wound in a roll form. Optionally, as shown in FIG. 4, the label web is provided and wound on a spool 34. To assist in winding, a label web winder 40 is guided back and forth along an axis parallel to the axis of the spool 34 as the spool rotates to apply the web to the spool. Alternatively, the web winder an rotate around the spool as desired. In either winding, the label web is applied to form an underlying web layer 64 and a subsequent overlying web layer 60. The overlying web layer is wound in the transverse orientation relative to the underlying web layer so that at least a portion of the overlying web layer overlaps a portion of the underlying web layer. Due to this overlap, the overlying web layer is transverse or lays across a portion of the underlying web layer. This process is repeated back and forth between the flanges 32 until the web is applied to a desired volume. Due to the transverse orientation of the varying layers of the web on the spool, the overall density of the label web on the spool is increased substantially.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a”, “an,” “the,” or “said,” is not to be construed as limiting the element to the singular.

The embodiments of the invention in which an exclusive property or privilege is claimed are defined as follows:

1. A label supply comprising:
a spool including a core having a circumference;
a label web including a continuous plastic liner and a plurality of labels, adjacent labels from the plurality of labels spaced from one another to define a void between the adjacent labels, each label having a length shorter than the circumference of the spool, the label web wound around the spool to form an underlying web layer and an overlying web layer, the overlying web layer overlapping and being in a transverse orientation relative to underlying web layer, at least one label of overlying web layer positioned to at least partially nest within the void of the underlying web layer, whereby the density of labels wound on the spool is increased.

2. The label supply of claim 1 wherein the plurality of labels are flat labels, each including a base adhered to the plastic liner with a pressure sensitive adhesive.

3. The label supply of claim 2 wherein the spool includes an axis, a first end and a second end distal from the first end.

4. The label supply of claim 3 wherein the underlying web layer is wound on the spool so that it spirals from the first end of the spool to the second end of the spool.

5. The label supply of claim 4 wherein the overlying web layer is wound on the spool so that it spirals back from the second end of the spool to the first end of the spool in the transverse orientation relative to the underlying layer.

6. The label supply of claim 1 wherein the plurality of labels are expanded content labels, each including a booklet, a base, and an overlaminate, the overlaminate secured over the booklet and to the base beyond an edge of the booklet.

7. A label supply comprising a continuous label web including a plurality of labels, each label secured to a plastic liner with an adhesive, the continuous label web spiral wound in a cylindrical roll, forming an underlying web layer and an overlying web layer, the overlying web layer being wound in a transverse orientation relative to the underlying web layer so that a portion of the overlying web layer overlaps a portion of the underlying web layer, whereby the number of labels in the label supply is increased.

8. The label supply of claim 7 wherein adjacent labels in the plurality of labels are positioned on the liner to form a void therebetween.

9. The label supply of claim 8 wherein at least one label in the overlying web layer nests at least partially in the void of an underlying web layer.

10. The label supply of claim 7 wherein the plurality of labels are flat pressure sensitive labels.

11. The label supply of claim 7 wherein the plurality of labels are expanded content labels.

12. The label supply of claim 7 comprising a core, the label web wrapped around the core.

13. The label supply of claim 12 wherein the core has a circumference, where each label from the plurality of labels has a length, and wherein the label length is less than the core circumference.

14. A method for increasing the number of labels in a label supply comprising:
providing a spool having a circumference;
providing a label web including a continuous plastic liner and a plurality of labels, each label having a length shorter than the circumference of the spool; and
winding the label web around the spool to form an underlying web layer and an overlying web layer, the overlying web layer being wound in a transverse orientation relative to the underlying web layer so that a portion of the overlying web layer overlaps a portion of the underlying web layer.

15. The method of claim 14 wherein the plurality of labels are spaced from one another to define voids therebetween.

16. The method of claim 15 comprising positioning the plurality of labels in an overlying web layer so that at least one of the labels to at least partially nests within a void of the underlying web layer to increase the density of labels on the spool.

17. The method of claim 16 comprising rotating the spool to wind the label web around the spool.
